(19) United States
(12) Patent Application Publication
(10) Pub. No.: US 2018/0109893 A1
(43) Pub. Date: Apr. 19, 2018

(54) HARD SPEAKER RADIATING DIAPHRAGMS WITH LIGHT-CURABLE VOICE COIL ATTACHMENT

(71) Applicant: BDNC (HOLDING) LIMITED, HONG KONG (CN)

(72) Inventor: Walter Ka Wai Chu, HONG KONG (CN)

(21) Appl. No.: 15/726,582

(22) Filed: Oct. 6, 2017

Related U.S. Application Data
(60) Provisional application No. 62/409,516, filed on Oct. 18, 2016.

(51) Int. Cl. H04R 31/00; H04R 9/06; H04R 7/12; H04R 7/16

(52) U.S. Cl. CPC H04R 31/006; H04R 9/06; H04R 9/025; H04R 7/16; H04R 7/12

(57) ABSTRACT

A vibration assembly for use in a speaker includes a supporting member, a light-transmissive rigid and hard diaphragm vibrating and propagating vibration for sound radiation in response to an actuating force, a flexible membrane having a first portion coupled to the rigid and hard diaphragm and configured to vibrate with the rigid and hard diaphragm, and having a second portion coupled to the supporting member for positioning the rigid and hard diaphragm, and a voice coil coupled to the rigid and hard diaphragm with a light-curing adhesive, and flowing therein an alternating current and passing therethrough magnetic lines of force generated by a magnet to provide the actuating force. The use of light-curing adhesive accelerates the automated manufacturing process.

### CROSS-REFERENCE TO RELATED APPLICATIONS

The present application is a nonprovisional application claiming benefit from a U.S. Provisional Patent Application bearing a Ser. No. 62/409,516 and filed Oct. 18, 2016, contents of which are incorporated herein for reference.

### FIELD OF THE INVENTION

The present invention relates to a vibration assembly, and more particular to a vibration assembly for use in a speaker, which includes a hard speaker radiating diaphragm with a light-curable voice coil attachment. The present invention also relates to a speaker including a hard speaker radiating diaphragm with a light-curable voice coil attachment.

### BACKGROUND OF THE INVENTION

A speaker is a device for converting an electrical audio signal into a corresponding sound. A variety of speakers have been developed and continue to be improved since the nineteenth century.

In general, an electrodynamic, direct-radiating speaker is mainly composed of a magnetic circuit assembly, a voice coil partially or wholly inside the magnetic circuit assembly, and a sound-radiating diaphragm mechanically attached to the voice coil; and in most cases, together with other supporting parts like the diaphragm surround, suspension, also referred to as the spider or the suspension, frame, etc. As a magnetic field resulting from the alternating current flowing through the coil interacts with a magnetic field from the magnetic-circuit assembly according to Fleming's rules, the voice coil actuates the attached portion of the diaphragm, thus the portion of the diaphragm vibrates, and propagates such vibration to the rest of the diaphragm area not directly adjacent to the voice coil. As a result, the sound radiates from the whole diaphragm area in a very complex manner due to the frequency-dependent and non-linearity in the sound-propagation, absorption (damping), and boundary reflection process. Therefore, the material, structure and configuration of the diaphragm significantly influences the sound quality of the speaker.

For example, European Patent Publication No. EP 2268058A1 discloses micro speakers, for example for use in reproducing sound in microelectronic equipment such as mobile phones, cellular phones, camcorders, PDAs, digital cameras, notebook computers, LCD TVs, DVDs and the like. The vibration system of the speaker comprises a voice coil 8 fitted into a gap between a permanent magnet 2 and the inner diameter of a yoke 4, as shown in FIG. 1. A speaker membrane M is bonded to the voice coil 8. The membrane M comprises an elastomer of thickness less than 0.3 mm and with a Young's modulus below 100 MPa, e.g. silicone. The elastomer membrane can be bonded to the coil 8 using conventional adhesives. As known to those skilled in the art, UV-curing adhesives are preferable as rapid curing is essential in automated manufacturing. Since the vibration system of the prior art further comprises a stiffening element 16 provided on the opposite side of the membrane M to the voice coil 8, the stiffening element 16, which is commonly made of an opaque material such as metal or a composite material including metal, or a polymer sheet formed with a relatively large thickness, might adversely affect the UV-curing of the adhesive. Even if the polymer sheet is light transmissible and applicable to the UV-curing process, some problems are still encountered. For example, without pre-treatment of the polymer surface (by primers, or plasma treatment), the vice-coil/polymer adhesion is weak and subject to peeling-off, especially under heat generated from the voice coil.

### SUMMARY OF THE INVENTION

The present invention provides a vibration assembly adapted to be use in a speaker, which includes a hard speaker radiating diaphragm with a light-curable voice coil attachment to improve the manufacturing efficiency.

In an aspect, the present invention provides a vibration assembly for use in a speaker, which comprises: a supporting member; a light-transmissive rigid and hard diaphragm vibrating and propagating vibration for sound radiation in response to an actuating force; a flexible membrane having a first portion coupled to the rigid and hard diaphragm and configured to vibrate with the rigid and hard diaphragm, and having a second portion coupled to the supporting member for positioning the rigid and hard diaphragm; and a voice coil coupled to the rigid and hard diaphragm with a light-curing adhesive, and flowing therein an alternating current and passing therethrough magnetic lines of force generated by a magnet to provide the actuating force by working in conjunction with the time-varying lines of force from the voice coil.

To achieve the desired performance, the light-transmissive rigid and hard diaphragm in this invention preferably has significant transmittance in UV-A band sufficient to allow curing of the light-curing adhesive, e.g. over 50 percent (>50%), a Young's modulus value over 50 GPa, together with a Mohs hardness value over 5.0.

Common materials that can meet with these three physical criteria include, but not limited to, single-crystal diamond, single-crystal alumina (optical-clear Sapphire), single-crystal Zirconia, many other metals' oxides or nitrides in single-crystal form, single-crystal silica (quartz), and amorphous silicon dioxide (glass). For cost and ease-of-manufacturing reasons, preferably, the rigid and hard diaphragm is formed of a substantially homogeneous amorphous material. For example, the rigid and hard diaphragm may be a glass sheet.

For exemplification only, the rigid and hard diaphragm may be a substantially flat sheet, a substantially bowl-shaped sheet or a substantially dome-shaped sheet. Alternatively, the rigid and hard diaphragm may be configured to include a downward or an upward curved inner portion and a flat surround portion where the voice coil is coupled, or the rigid and hard diaphragm is configured to be slightly downward curved in an inner portion and more aggressively downward curved in a surround portion outside a magnetic circuit assembly of the speaker, which includes the magnet.

For exemplification only, the flexible membrane may be formed of a soft polymeric material.

The flexible membrane and the voice coil may be disposed at opposite sides of the rigid and hard diaphragm. Alternatively, the rigid and hard diaphragm and the voice coil are disposed at opposite sides of the flexible membrane.

The rigid and hard diaphragm may entirely or partially overlap with the first portion of the flexible membrane.

In an embodiment, the vibration assembly further comprises an auxiliary layer coupled to the rigid and hard diaphragm and/or the flexible membrane for enhancing heat-dissipating capability and/or modifying acoustic performance.

For example, the auxiliary layer is an aluminum foil, a deposited metal layer or a graphite sheet.

In another aspect, the present invention provides a speaker for sound radiation, which comprises: a frame; a magnetic circuit assembly for inducing magnetic lines of force; a magnet-pot receiving therein the magnetic circuit assembly, and accommodated in the frame; and a vibration assembly accommodated in the frame. The vibration assembly comprises: a light-transmissive rigid and hard diaphragm vibrating and propagating vibration for sound radiation in response to an actuating force; a flexible membrane having a first portion coupled to the rigid and hard diaphragm and configured to vibrate with the rigid and hard diaphragm, and having a second portion coupled to an inner surface of the frame for positioning the rigid and hard diaphragm; and a voice coil coupled to the rigid and hard diaphragm with a light-curing adhesive, and flowing therein an alternating current and passing therethrough the magnetic lines of force to provide the actuating force.

For exemplification only, the magnetic circuit assembly may include a magnet disposed in a hollow center of the voice coil, and/or a magnet surrounding the voice coil. Alternatively, the magnetic circuit assembly includes a plurality of pieces of magnets disposed in a circular trench of the yoke together with the voice coil.

### BRIEF DESCRIPTION OF THE DRAWINGS

The invention will become more readily apparent to those ordinarily skilled in the art after reviewing the following detailed description and accompanying drawings, in which:

FIG. 1 is a cross-sectional view schematically illustrating a prior art vibration system for use in a speaker;

FIG. 2 is a cross-sectional view schematically illustrating a vibration assembly adapted to be used in a speaker according to a first embodiment of the present invention;

FIG. 3 is a cross-sectional view schematically illustrating a first embodiment of speaker comprising the vibration assembly as illustrated in FIG. 2;

FIG. 4 is a cross-sectional view schematically illustrating an example of the rigid and hard diaphragm used in vibration assembly of FIG. 2;

FIG. 5 is a cross-sectional view schematically illustrating a vibration assembly adapted to be used in a speaker according to a second embodiment of the present invention;

FIG. 6 is a cross-sectional view schematically illustrating a vibration assembly adapted to be used in a speaker according to a third embodiment of the present invention;

FIG. 7A is a cross-sectional view schematically illustrating a vibration assembly adapted to be used in a speaker according to a fourth embodiment of the present invention;

FIG. 7B is a cross-sectional view schematically illustrating a vibration assembly adapted to be used in a speaker according to a fifth embodiment of the present invention;

FIG. 7C is a cross-sectional view schematically illustrating a vibration assembly adapted to be used in a speaker according to a sixth embodiment of the present invention;

FIG. 7D is a cross-sectional view schematically illustrating a vibration assembly adapted to be used in a speaker according to a seventh embodiment of the present invention;

FIG. 7E is a cross-sectional view schematically illustrating a vibration assembly adapted to be used in a speaker according to an eighth embodiment of the present invention;

FIG. 8A is a cross-sectional view schematically illustrating a vibration assembly adapted to be used in a speaker according to a ninth embodiment of the present invention;

FIG. 8B is a cross-sectional view schematically illustrating a vibration assembly adapted to be used in a speaker according to a tenth embodiment of the present invention;

FIG. 8C is a cross-sectional view schematically illustrating a vibration assembly adapted to be used in a speaker according to an eleventh embodiment of the present invention;

FIG. 8D is a cross-sectional view schematically illustrating a vibration assembly adapted to be used in a speaker according to a twelfth embodiment of the present invention;

FIG. 9A is a cross-sectional view schematically illustrating a second embodiment of speaker comprising the vibration assembly as illustrated in FIG. 2;

FIG. 9B is a cross-sectional view schematically illustrating a third embodiment of speaker comprising the vibration assembly as illustrated in FIG. 2;

FIG. 9C is a cross-sectional view schematically illustrating a fourth embodiment of speaker comprising the vibration assembly as illustrated in FIG. 2; and

FIG. 9D is a cross-sectional view schematically illustrating a fifth embodiment of speaker comprising the vibration assembly as illustrated in FIG. 2.

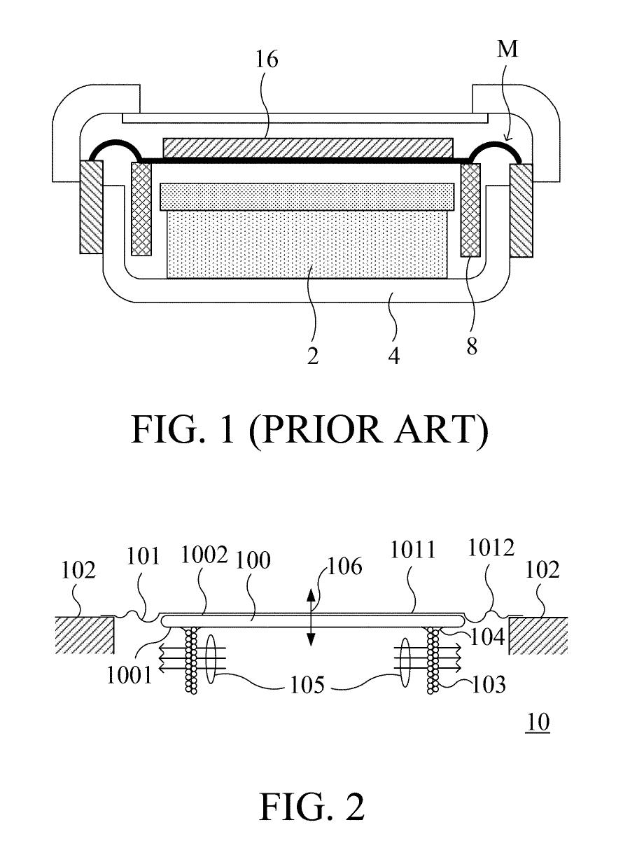

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

Referring to FIG. 2, a cross-section view of a vibration assembly adapted to be used in a speaker according to an embodiment of the present invention is illustrated. The vibration assembly 10 includes a rigid and hard diaphragm 100, a flexible membrane 101, a supporting member 102 and a voice coil 103. In this embodiment, the rigid and hard diaphragm 100 is made of light-transmissible material, and the voice coil 103 is secured onto a surface 1001 of the rigid and hard diaphragm 100 with a light curable adhesive 104. An inner portion 1011 of the flexible membrane 101 is attached on a surface 1002 of the rigid and hard diaphragm 100 opposite to the surface 1001 where the voice coil 103 is disposed, and entirely overlaps with the rigid and hard diaphragm 100. The flexible membrane 101 is further coupled to the supporting member 102 with a surrounding portion 1012 extending outwards from the inner portion 1011.

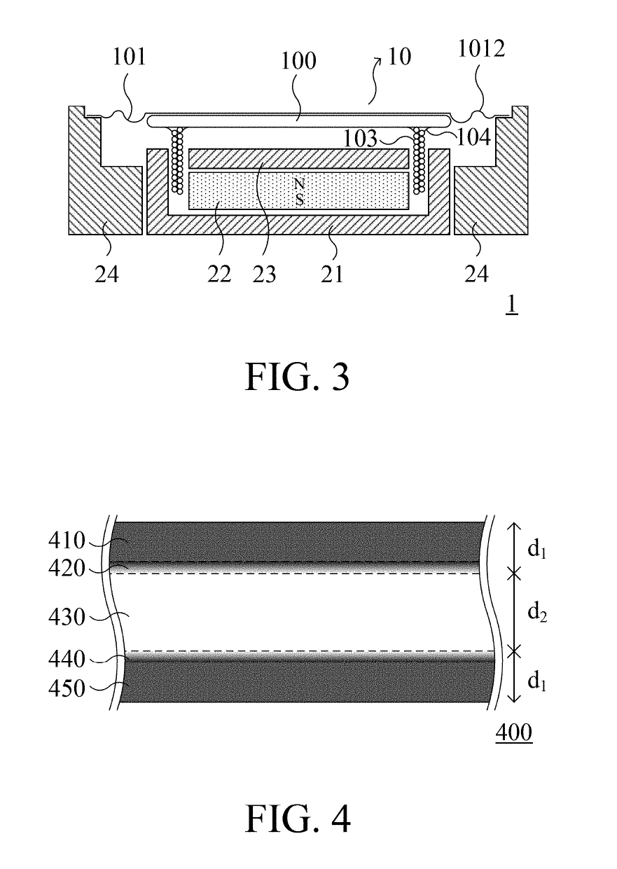

Please refer to FIG. 3. A cross-sectional view of a partial speaker, which comprises the vibration assembly 10 as described above, is schematically illustrated. The speaker 1, in addition to the vibration assembly 10, further includes a magnet-pot 21, a permanent magnet 22, a top-plate 23, and a frame 24. The magnet-pot 21 is, for example, U-shaped and made of steel for receiving the vibration assembly 10. The permanent magnet 22 is received in the magnet-pot 21, and covered by the top-plate 23, which is, for example, made of steel, and disposed as a core of the voice coil 103. The vibration assembly 10, the magnet-pot 21, the permanent magnet 22, and the top-plate 23 are accommodated in the frame 24, which is, for example, made of a plastic material, and configured to serve as the supporting member for the surrounding portion 1012 of the flexible membrane 101 to rest.

The permanent magnet 22 generates magnetic flux 105 radially through the coil 103 as indicated by the arrows in FIG. 2. Due to the interaction between the magnetic flux 105 from the permanent magnet and the flux resulting from the current flowing through the voice coil 103, the vibration assembly, including the rigid and hard diaphragm 100, the flexible membrane 101 and the voice coil 103, conducts a corresponding mechanical movement 106 as indicated by the arrow in FIG. 2.

In this embodiment, the flexible membrane is made of a soft polymeric material, which permits deformation to a desired extent and assures of recovery to the original state. The rigid and hard diaphragm 100 is a thin glass sheet, which is transparent to light up to most of the UV ranges, so the vibration assembly 10 can be formed by stacking the voice coil 103, the glass sheet 100 and the flexible membrane 101 in sequence with a UV-curing adhesive, thereby speeding up the automated curing process. Advantageously, heat can be applied to the voice-coil/glass adhesion to accelerate the curing process as glass will not permanently deform nor melt under normal heat-curing temperature of the adhesive, which is normally over 120° C. but less than 200° C. Due to the high specific stiffness of the glass, the rigid and hard diaphragm can be made into a very thin sheet while keeping the required stiffness against diaphragm distortion due to air pressure difference during vigorous diaphragm vibrations. The glass diaphragm can also serve as a heat-sink for the voice coil due to its relatively high thermal conductivity over polymer films (Glass ˜1 W/mk vs. PET ˜0.2 W/mk vs. Air ˜0.024 W/mk). Furthermore, the voice-coil/glass adhesion is highly resistant to peeling off under shearing force, as both parts are hard. Ultrasonic radiation beyond a human audible range is possible due to the excellent acoustic properties of glass, less boundary interface by adhesives, and possible use of hard-after-curing type of adhesives.

It is to be noted that the thin glass sheet is only an example of the rigid and hard diaphragm, and any other suitable light-transmissible hard speaker radiating diaphragm, preferably glass-based, can be used in the present invention, as long as the above-mentioned advantages can be achieved. For example, in a co-pending U.S. patent application Ser. No. 15/673,554 filed by the same Applicant, the contents of which are incorporated herein for reference, a diaphragm structure based upon an amorphous compressed skins—tensioned core structure is proposed. Referring to FIG. 4, an embodiment of the amorphous compressed skins-tensioned core structure 400 includes an upper surface layer 410, an upper transition layer 420, a core 430, a lower transition layer 440 and a lower surface layer 450, and each layer comprises substantially the same hard homogeneous amorphous material with variations in internal stress resulting from the density distribution of guest ions in the upper surface layer 410, upper transition layer 420, lower transition layer 440, and lower surface layer 450, which vary by depth from the skin, as a result of chemical ion exchange occurring when the untreated piece of glass is immersed in a high temperature molten salt bath creating the compressive stress layer 410 and 450, and the corresponding transition layer 420 and 440, and compensating tension in the core 430, forming the amorphous compressed skins—tensioned core structure 400. In a preferable embodiment, the light-transmissive rigid and hard diaphragm 100 has transmittance in UV-A band over 50 percent (>50%), a Young's modulus value over 50 GPa, together with a Mohs hardness value over 5.0.

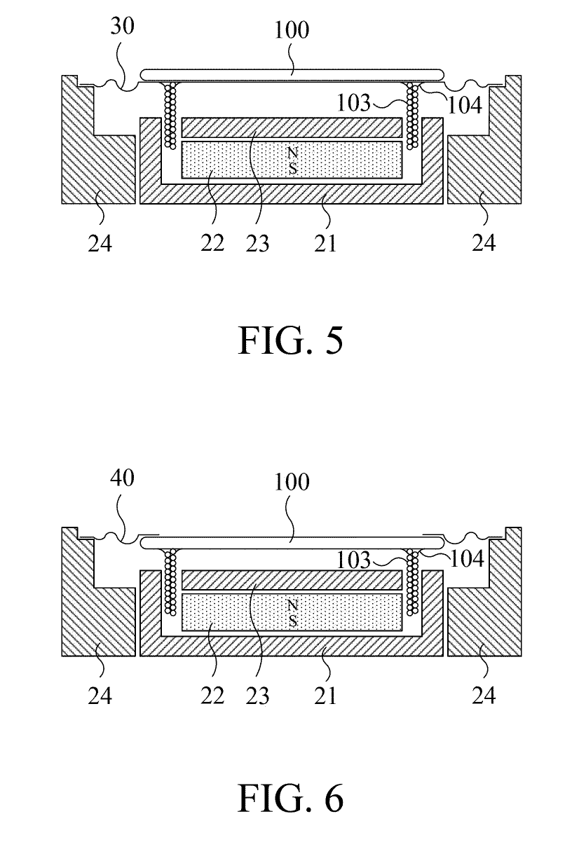

FIG. 5 schematically illustrates another embodiment of vibration assembly according to the present invention. In this embodiment, the flexible membrane is implemented with a flexible membrane 30, which is disposed between the voice coil 103 and the rigid and hard diaphragm 100, and made of a material that has a good adhesion to voice coil 103 via the light-curing adhesive 104. Meanwhile, the rigid and hard diaphragm 100 is still required to be a light-transmissible hard diaphragm for use with the light-curing adhesive 104.

FIG. 6 schematically illustrates a further embodiment of vibration assembly according to the present invention. In this embodiment, the flexible membrane is implemented with a flexible membrane 40, which is disposed at a side of the rigid and hard diaphragm 100 opposite to the voice coil 103. The flexible membrane 40 is a ring-shaped. That is, the flexible membrane 40 has a hollow inner portion and partially covers the rigid and hard diaphragm 100, which provides a reduction in mass

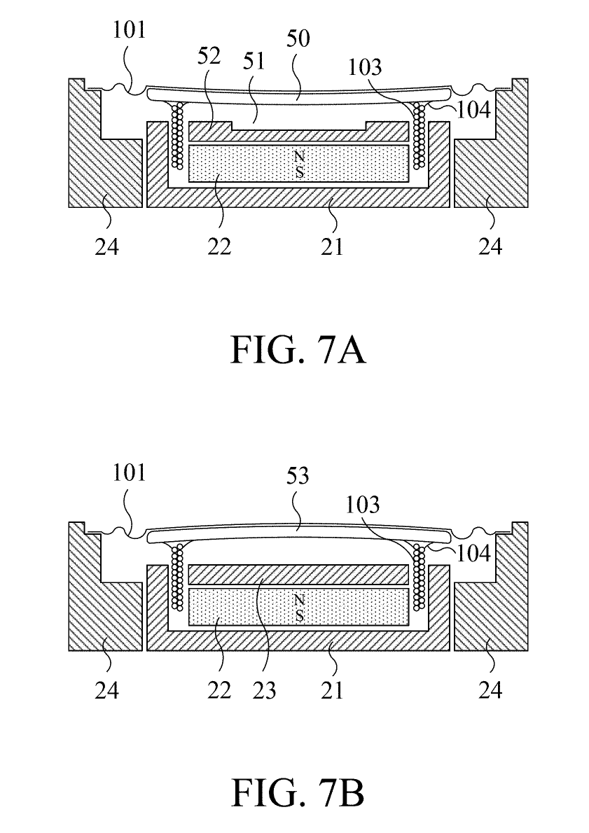

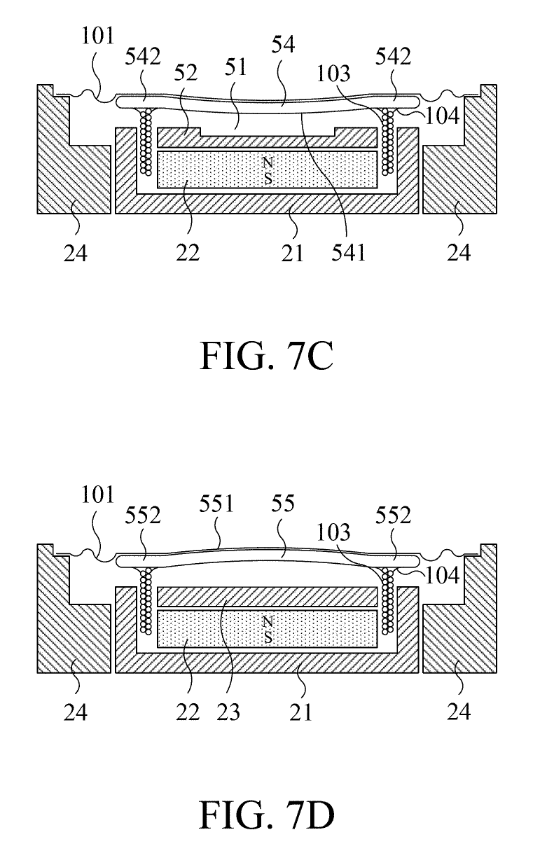

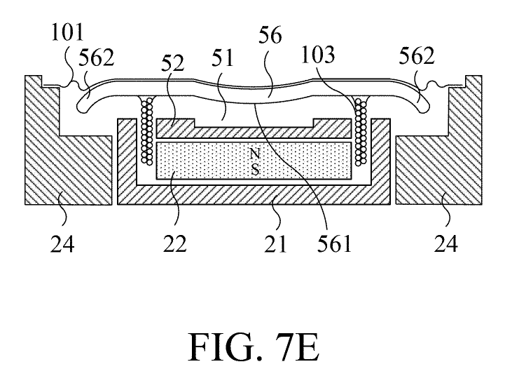

FIGS. 7A-7E schematically illustrate still further embodiments of vibration assemblies according to the present invention to further increase the rigidity of the rigid and hard diaphragm. In the embodiment illustrated in FIG. 7A, the rigid and hard diaphragm is a bowl-shaped glass sheet 50. For avoiding contact or collision while the diaphragm is vibrating, a notch or hole 51 is made in the top plate 52 at a position corresponding to the bowl bottom of the rigid and hard diaphragm 50. In the embodiment illustrated in FIG. 7B, the rigid and hard diaphragm is a dome-shaped glass sheet 53. In the embodiment illustrated in FIG. 7C, the rigid and hard diaphragm 54 has a downward curved main body 541 and a flat flange 542 for better adhering operation to the voice coil 103. In the embodiment illustrated in FIG. 7D, the rigid and hard diaphragm 55 has an upward curved main body 551 and a flat flange 552 for better adhering operation to the voice coil 103. In the embodiment illustrated in FIG. 7E, the rigid and hard diaphragm 56 has a slightly downward curved inner portion 561 and a more aggressively downward curved surround portion 562, wherein such aggressive curve shape will not impact the overall speaker thickness since it is outside the magnet-pot 21. Likewise, a notch or hole may be provided under any of the rigid and hard diaphragms, if a reduction of total speaker thickness is needed.

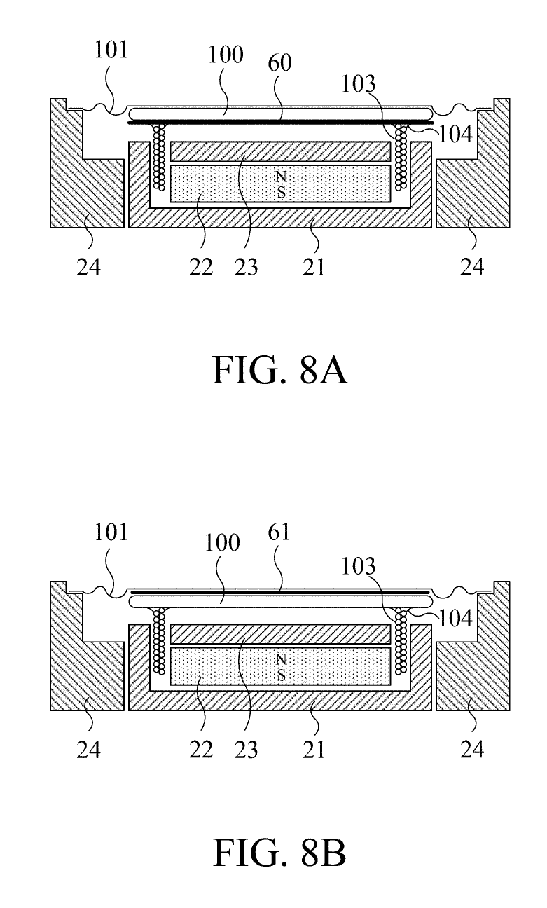

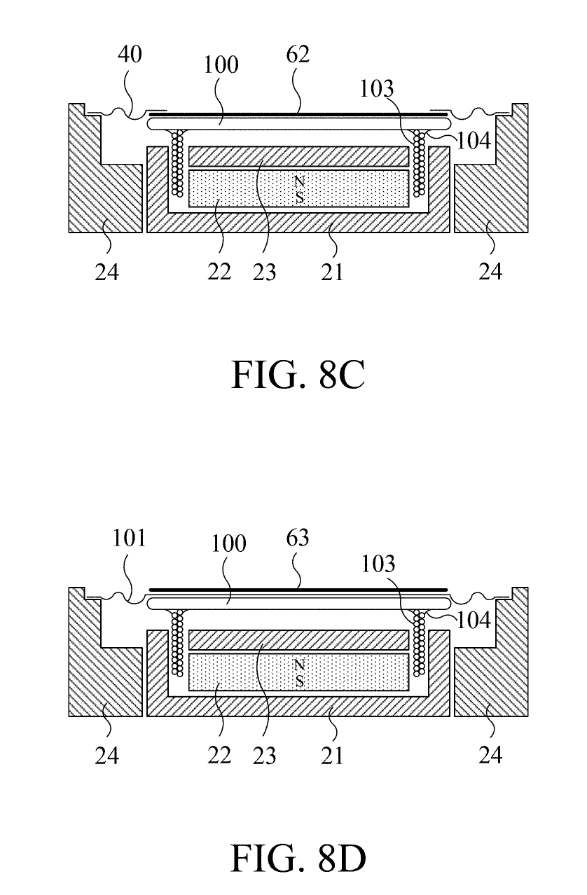

Although a light-transmissive rigid and hard diaphragm is preferred for use with a light-curing adhesive to stack with a voice coil, the light-transmissive rigid and hard diaphragm such as the one proposed in the co-pending U.S. patent application Ser. No. 15/673,554 filed by the same Applicant may also be used with other types of adhesives. In these embodiments, an auxiliary layer may be additionally provided in the vibrating assembly for enhancing some physical properties of the vibration assembly. For example, as depicted in FIGS. 8A-8D, the auxiliary layer 60 may be an aluminum foil, a deposited metal layer or a graphite sheet, which is advantageous in acting as the heat-spreader for the heat generated for the voice coil 103, and has specific effects on modifying acoustic performance. The auxiliary layer 60 may be arranged in a variety of positions, depending on practical applications and requirements, wherein FIG. 8A illustrates the position of the auxiliary layer 60 between the rigid and hard diaphragm 100 and the voice coil 103; FIG. 8B illustrates the position of the auxiliary layer 60 between the rigid and hard diaphragm 100 and the flexible membrane 101; FIG. 8C illustrates the position of the auxiliary layer 60 between the rigid and hard diaphragm 40 and the voice coil 103; and FIG. 8D illustrates the position of the auxiliary layer 60 on a surface of the voice coil 103 opposite to the rigid and hard diaphragm 100. In these embodiments, a flat rigid and hard diaphragm is used as an example for illustrating the disposition of the auxiliary layer 60. Nevertheless, other configurations of rigid and hard diaphragms as described above may also be used for achieving desired purposes.

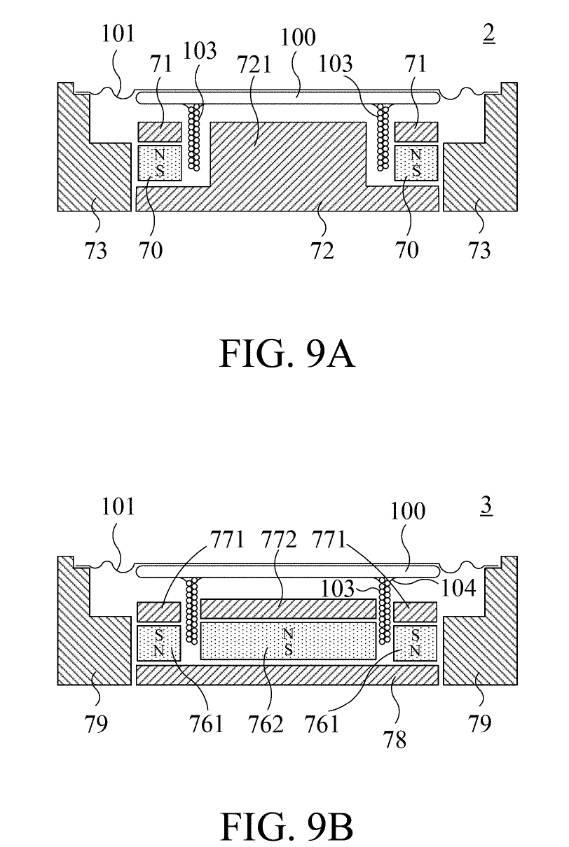

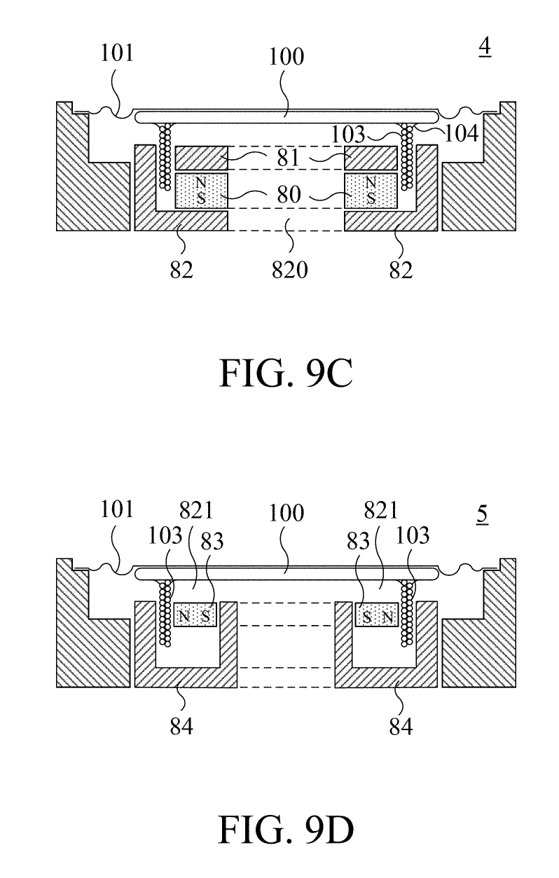

The vibration assemblies as proposed in the above embodiments may be used in a speaker together with various types of magnetic designs. In the embodiment of speaker 2 as illustrated in FIG. 9A, a ring magnet 70 outside the voice coil 103 is used. The ring magnet 70 is covered with a ring-shaped top plate 71, seated in a T-yoke 72, which has a protrusion 721 inside the hollow voice coil 103, and surrounded with a frame 73. The allocation of the magnet 70, the top plate 71 and the T-yoke 72 is not only for securing the disposition of the magnet 70, but also plays a role of distributing magnetic lines of force associated with the magnet 70 in order to optimize the interaction between the voice coil 103 and the magnetic lines of force.

In the embodiment of speaker 3 illustrated in FIG. 9B, a magnetic circuit assembly including a disc magnet 762 and a ring magnet 761 is used. The magnetic circuit is implemented with a ring-shaped top plate 771, a disc-shaped top plate 772, and a disc-shaped base plate 78, with the ring magnet 771 seating in between ring-shaped top plate 771 and base plate 78, together with the disc magnet 772 seating in between the top plate 772 and the base plate 78. The voice coil 103 is placed in the magnetic gap formed between the ring-shaped top plate 771 and the disc-shaped top plate 772. This magnetic circuit arrangement can provide a higher magnetomotive force over the simple magnetic circuit arrangement as illustrated in FIG. 3 and FIG. 9A.

In the embodiment of speaker 4 illustrated in FIG. 9C, the magnet 80 is a ring magnet and disposed inside the voice coil 103. A top plate 81 has a similar ring shape to a cross section of the magnet 80. The magnet 80 is seated in a magnet pot 82, which has a hole 820 aligned with the hollow portions of the magnet 80 and the top plate 81. Such configuration can reduce the weight of the speaker assembly, and provide a vent for the back air-flow.

In the embodiment of speaker 5 illustrated in FIG. 9D, a plurality of pieces of magnets 83 are used. The magnets 83 are disposed in a circular trench 821 of a steel yoke 84, and so is the voice coil 103.

It is understood from the above descriptions, by using a hard speaker radiating diaphragm, and more specifically a light-transmissive hard speaker radiating diaphragm, in the vibration assembly, the voice coil attachment can be well performed with, for example, a light-curing adhesive. It is to be noted that the variations and alternatives of the shapes, materials and positions of the rigid and hard diaphragm, flexible membrane, magnet, top plate and magnet-pot, in spite being described in different embodiments, may be arbitrarily combined by those skilled in the art to achieve desired objectives.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A vibration assembly for use in a speaker, comprising:
a supporting member;
a light-transmissive rigid and hard diaphragm vibrating and propagating vibration for sound radiation in response to an actuating force;
a flexible membrane having a first portion coupled to the rigid and hard diaphragm and configured to vibrate with the rigid and hard diaphragm, and having a second portion coupled to the supporting member for positioning the rigid and hard diaphragm; and
a voice coil coupled to the rigid and hard diaphragm with a light-curing adhesive, and flowing therein an alternating current and passing therethrough magnetic lines of force generated by a magnet to provide the actuating force.

2. The vibration assembly according to claim 1, wherein the supporting member is a frame of the speaker, where the vibration assembly is accommodated.

3. The vibration assembly according to claim 1, wherein the rigid and hard diaphragm is formed of a substantially homogeneous amorphous material.

4. The vibration assembly according to claim 1, wherein the rigid and hard diaphragm has transmittance in UV-A band sufficient to allow curing of the light-curing adhesive, a Young's modulus value over 50 GPa, together with a Mohs hardness value over 5.0.

5. The vibration assembly according to claim 1, wherein the rigid and hard diaphragm is a glass sheet.

6. The vibration assembly according to claim 1, wherein the rigid and hard diaphragm is a substantially flat sheet.

7. The vibration assembly according to claim 1, wherein the rigid and hard diaphragm is a substantially bowl-shaped sheet or a substantially dome-shaped sheet.

8. The vibration assembly according to claim 1, wherein the rigid and hard diaphragm is configured to include a downward or an upward curved inner portion and a flat surround portion where the voice coil is coupled.

9. The vibration assembly according to claim 1, wherein the rigid and hard diaphragm is configured to be slightly downward curved in an inner portion and more aggressively downward curved in a surround portion outside a magnetic circuit assembly of the speaker, which includes the magnet.

10. The vibration assembly according to claim 1, wherein the flexible membrane is formed of a soft polymeric material.

11. The vibration assembly according to claim 1, wherein the flexible membrane and the voice coil are disposed at opposite sides of the rigid and hard diaphragm.

12. The vibration assembly according to claim 1, wherein the rigid and hard diaphragm and the voice coil are disposed at opposite sides of the flexible membrane.

13. The vibration assembly according to claim 1, wherein the whole rigid and hard diaphragm overlaps with the first portion of the flexible membrane.

14. The vibration assembly according to claim 1, wherein the first portion of the flexible membrane is ring-shaped, and the rigid and hard diaphragm is partially uncovered from the first portion of the flexible membrane.

15. The vibration assembly according to claim 1, further comprising an auxiliary layer coupled to the rigid and hard diaphragm and/or the flexible membrane for enhancing heat-dissipating capability and/or modifying acoustic performance.

16. The vibration assembly according to claim 1, wherein the auxiliary layer is an aluminum foil, a deposited metal layer or a graphite sheet.

17. A speaker for sound radiation, comprising:
a frame;
a magnetic-circuit assembly for conducting magnetic lines of force;
a magnet-pot receiving therein the magnetic-circuit assembly, and accommodated in the frame; and
a vibration assembly accommodated in the frame, comprising:
a light-transmissive rigid and hard diaphragm vibrating and propagating vibration for sound radiation in response to an actuating force;
a flexible membrane having a first portion coupled to the rigid and hard diaphragm and configured to vibrate with the rigid and hard diaphragm, and having a second portion coupled to an inner surface of the frame for positioning the rigid and hard diaphragm; and
a voice coil coupled to the rigid and hard diaphragm with a light-curing adhesive, and flowing therein an alternating current and passing therethrough the magnetic lines of force to provide the actuating force.

18. The speaker according to claim 17, wherein the magnetic-circuit assembly includes a magnet disposed in a hollow center of the voice coil.

19. The speaker according to claim 18, wherein the magnet is a ring magnet.

20. The speaker according to claim 17, wherein the magnetic-circuit assembly includes a magnet outside the voice coil.

21. The speaker according to claim 17, wherein the magnetic-circuit assembly includes a plurality of pieces of magnets disposed in a circular trench of the magnet-pot together with the voice coil.
